(19) United States
(12) Patent Application Publication
(10) Pub. No.: US 2018/0375234 A1
(43) Pub. Date: Dec. 27, 2018

(54) Flexible Twisted Cable With End Connectors

(71) Applicant: Robert Baschnagel, Garden City, NY (US)

(72) Inventor: Robert Baschnagel, Garden City, NY (US)

(21) Appl. No.: 16/019,375

(22) Filed: Jun. 26, 2018

Related U.S. Application Data
(62) Division of application No. 14/594,160, filed on Jan. 11, 2015, now abandoned.

(51) Int. Cl. H01R 11/24

(52) U.S. Cl. CPC H01R 11/24

(57) ABSTRACT

A cable for supporting an electronic device having a display. The cable including: a body having two or more elongated wires twisted together to form a helically wound pair of wires having two ends; and a connector disposed at each end, each connector having first and second jaws rotatably disposed relative to each other about a pivot joint so as to be openable and closable, the first and second jaws having first and second plates, respectively, extended from the pivot joint, the first and second plates being biased towards each other and configured to hold the electronic device so as to direct the display to a user; wherein at least a portion of the body has a rigidity such that it can be shaped into a predetermined configuration and maintained in the predetermined configuration under a weight of the electronic device with the display being directed to the user.

### CROSS-REFERENCE TO RELATED APPLICATION

This application is a Divisional Application of U.S. patent application Ser. No. 14/594,160, filed on Jan. 11, 2018, the entire contents of which is incorporated herein by reference.

### BACKGROUND

### Field

This disclosure relates generally to twisted wire cables that can be manipulated into various configurations for connecting to other cables and/or supporting one or more objects, such as electrical/electronic devices.

### Prior Art

Cables, such as those having a Universal Serial Bus (“USB” hereinafter) connector or headphones jack or smartphone connectors for electronic devices, such as a cell phone, are known in the prior art. Nevertheless, such cables cannot support the electronic device in a predetermined position/orientation (referred to hereinafter as simply “position”), such as supporting the cell phone in a standing position while it is being used, charged or synchronized. Electronic devices are defined herein as including but are not limited to mobile phones, smart phones, and multimedia players. Furthermore, such cables are also incapable of supporting itself in a predetermined position.

### SUMMARY

Accordingly, a cable is provided. The cable comprising: a body having two or more elongated wires twisted together to form a helically wound pair of wires having two ends; and a connector disposed at each of the two ends; wherein at least a portion of the body has a rigidity such that the portion can be shaped into a predetermined configuration and maintained in the predetermined configuration under a given load.

The cable can further comprise a cover for one of individually covering each of the elongated wires or covering the helically wound pair of wires.

Each connector can includes a body, a first jaw fixed to the body and a second jaw rotatably disposed on the body to open and close relative to the first jaw. The second jaw can be biased in a closed position relative to the first jaw. The second jaw can be rotatable relative to the first jaw about an axis orthogonal to a longitudinal axis of the body.

Each connector can include means for releasably connecting a fitting to each connector. The means for connecting can include a pin projecting from a surface of each connector for engaging with a corresponding hole on the fitting. The cable can further comprise a spring member having the pin disposed thereon and capable of elastically deforming relative to the surface.

The cable can further comprise a plurality of fibers disposed between wires of the helically wound pair of wires.

The cable can further comprise one or more additional wires extending from the helically wound pair of wires and elastically deformable to support an object on the helically wound pair of wires.

Also provided is a cable system comprising: a body having two or more elongated wires twisted together to form a helically wound pair of wires having two ends, wherein at least a portion of the body has a rigidity such that the portion can be shaped into a predetermined configuration and maintained in the predetermined configuration under a given load; a connector disposed at each of the two ends; means for releasably connecting a fitting to one or both of the connectors; and a fitting releasably disposed on the one or both connectors.

The means for connecting can include a pin projecting from a surface of each connector for engaging with a corresponding hole on the fitting. The cable can further comprise a spring member having the pin disposed thereon and capable of elastically deforming relative to the surface.

The fitting can comprise two or more female legs, each releasably connecting with a connector of another cable. The fitting can be selected from a group consisting of an elbow, a coupling, a cross, a Y connector, a T connector, a multi connector, a corner connector, a suction cup, a whiteboard, a fan and a magnifying glass. At least one portion between female legs can be a flexible portion such that a relative angle between female legs can be varied.

The connector can comprise a body having first and second jaws movable relative to each other between an open and closed position. One of the first and second jaws can be biased in a closed position relative to the other of the first and second jaws. One of the first and second jaws can be rotatable relative to the other of the first and second jaws about an axis orthogonal to a longitudinal axis of the body. The fitting can comprise a body having third and fourth jaws movable relative to each other between an open and closed position, wherein one of the third and fourth jaws is rotatable relative to the other of the first and second jaws about an axis parallel to the longitudinal axis of the body.

### BRIEF DESCRIPTION OF THE DRAWINGS

These and other features, aspects, and advantages of the apparatus of the present invention will become better understood with regard to the following description, appended claims, and accompanying drawings where:

FIG. 1a is a perspective view of a twisted cable having end connector clamp fittings at each of first and second ends.

FIG. 1b is a close up view of one of the connector clamps of FIG. 1a.

FIG. 1c is a perspective view of a twisted cable having end connector fittings with a suction cup attached to an end connector fitting at a first end and a white board attached to an end connector fitting at another end.

FIG. 1d illustrates an alternative type of fitting attachment.

FIG. 2 illustrates a perspective view of the suction cup fitting of FIG. 1c.

FIG. 3 illustrates a perspective view of a magnifying glass fitting having a female end connector.

FIG. 4 is a perspective view of a cable having an end connector fitting with a fan attached to a first end and a male gator clip attached to an end connector fitting at another end.

FIG. 5a is a perspective view of a twisted cable having end connector fittings with a side clamp attached to each end connector fitting at first and second ends which support another article, such as an iPad, white board or clip board over a door knob.

FIG. 5b is a perspective side view of the twisted cable assembly of FIG. 5a configured to stand upright.

FIGS. 6a and 6b illustrate the side clamps of FIGS. 5a and 5b.

FIG. 7 is a perspective view of a plurality of twisted cables having end connector fittings that are fitted together to form a cube shape.

FIG. 8 is a partial isometric view of a corner of the cube shape of FIG. 7.

FIG. 9 is a side view of a flexible female×female fitting for use with the twisted cables.

FIG. 10 is a perspective view of a female×female fitting for use with the twisted cables.

FIG. 11 illustrates a perspective view of a rigid female×female corner fitting for use with the twisted cables.

FIG. 12 illustrates a perspective view of a multi-female fitting for use with the twisted cables.

FIG. 13 illustrates a perspective view of a T female fitting for use with the twisted cables, FIG. 14 illustrates a perspective view of a 4-point female fitting for use with the twisted cables.

FIG. 15 illustrates a perspective view of a Y female fitting for use with the twisted cables.

FIG. 16 illustrates a perspective view of one of two identical ends of a twisted wire cable having an alternative connector clamp.

FIG. 17 illustrates the cable of FIG. 16 with a portion of a cover removed to expose the twisted wires.

FIG. 18 illustrates the cable of FIG. 16 showing each end thereof.

FIG. 19 illustrates the cable of FIG. 16 having an adapter connector.

FIG. 20a illustrates the cable of FIG. 19 with the adapter connector connected thereto and holding another object.

FIG. 20b illustrates a cable having an alternative adapter connector connected thereto and capable of attaching to objects of various sizes.

FIG. 21 illustrates the cable of FIG. 19 showing each of both ends of the adapter connector holding a tablet and configured as a stand and alternatively designed for a holiday theme.

FIG. 22 illustrates the cable of FIG. 21 having another holiday theme in which material is disposed between the twists of the twisted wires.

FIG. 23 illustrates the cable of FIG. 19 showing each of both ends of the adapter connector configured to hang the tablet.

FIG. 24 illustrates another variation of the twisted cable having additional wires for holding an object, such as a smart phone.

FIG. 25 illustrates the twisted cable of FIG. 24 showing a pair of wires disposed near the connectors.

FIG. 26 illustrates the twisted cable of FIG. 24 showing a wire disposed between the connectors.

FIG. 27 illustrates the wire of FIG. 26 in a stored configuration.

### DETAILED DESCRIPTION

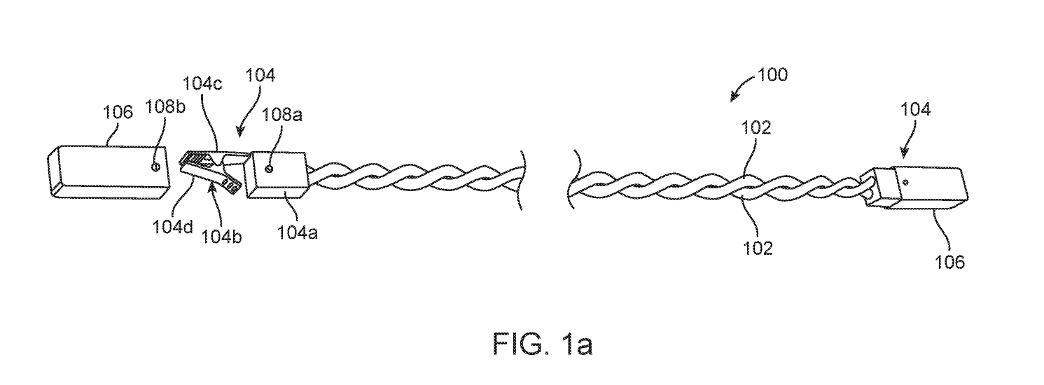

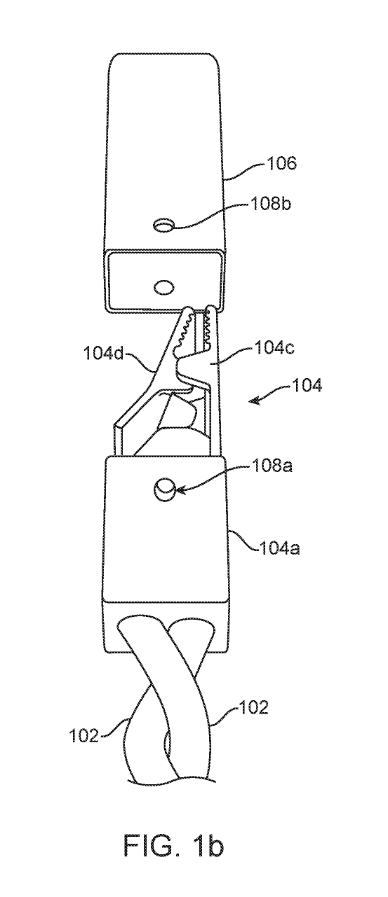

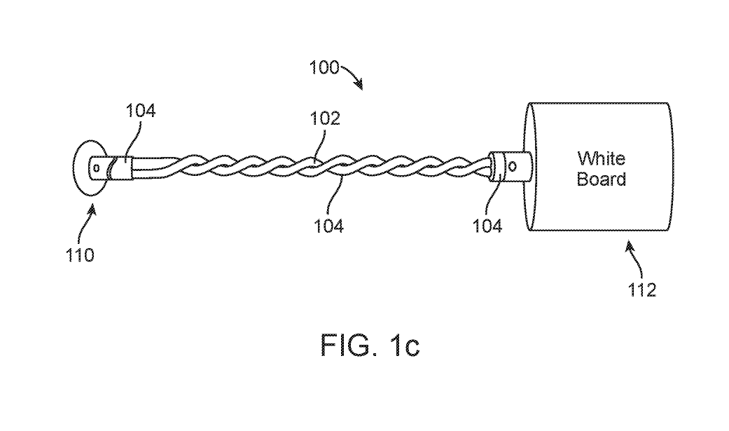

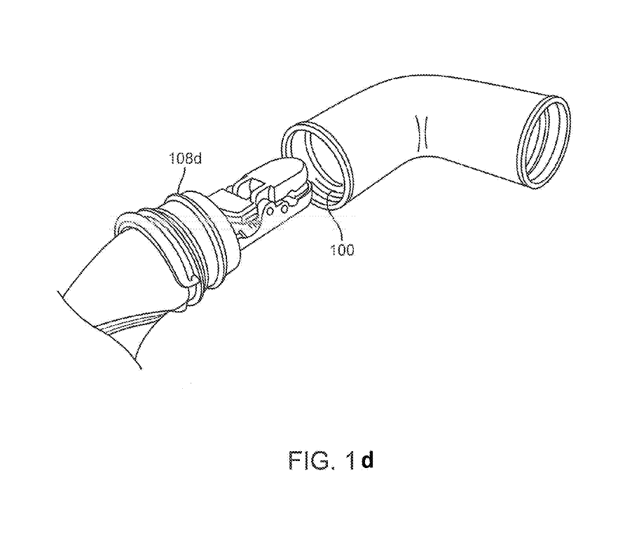

Referring to FIGS. 1a and 1b, the same shows a first configuration of a twisted wire cable generally referred to by reference numeral 100. The cable 100 includes a pair of twisted wires 102 which are formed of metal having flexibility, such as aluminum or copper and which can deform and return to its original shape and support a load while deformed into a predetermined shape. The twisted wires 102 are twisted in a helical configuration and can be exposed or include a cover (see below), such as an elastomer, such as silicon. Each of the wires 102 can be individually coated with the cover and/or the pair can be coated with the cover. Each end of the cable 100 includes a connector 104 connected to a corresponding end of the twisted wires 102, by any means known in the art, such as adhering, welding, brazing, press fit and/or crimping. The connector 104 includes a body 104a connected to the twisted wires 102 and a clamp 104b, such as an alligator clamp, the configuration of which is well known in the art. In general, the alligator clamp has a first jaw 104c fixed to the body 104a and a second jaw 104d rotatably connected to the first jaw 104c such that the second jaw 104d is biased into a closed position with respect to the first jaw 104c, such as with a spring element. As also shown in FIG. 1b, the cable 100 can also include covers 106 for each of the connectors 104, in which a hole 104b engages a corresponding post 108a on the body 104a when the cover 108 is plastically deformed to slide over the post 108a. Alternatively, the post 108a can be spring loaded and deform inwards until the hole 108b aligns with the post 108a.

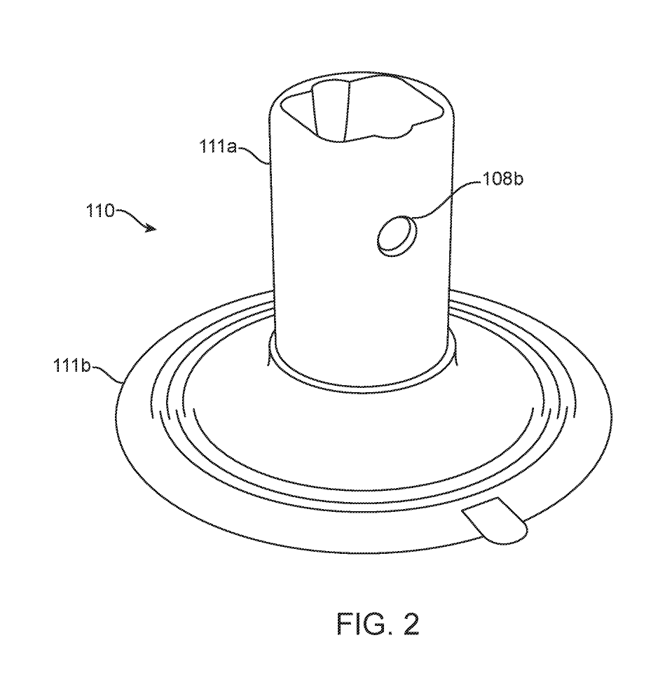

Referring now to FIG. 1c, besides the covers 108, additional fittings can also be used to connect to the connectors 104, such as a suction cup 110 attached to the connector 104 at a first end and a white board 112 attached to a connector 104 at another end. The suction cup 110 is shown in FIG. 2 having a female body 110a, hole 108b and a suction cup body 110b. In addition, besides the post 108a and hole 108b attachment, other attachments types can use used to attach the various fittings to the end connectors, such as clamp on, clip on, hook on, magnetic, suction, tie on, pin on, wedge in and slide track connections. An alternative connection type is shown in FIG. 1d in which the fitting includes an internal thread 108c and the end connector includes a mating external thread 108d.

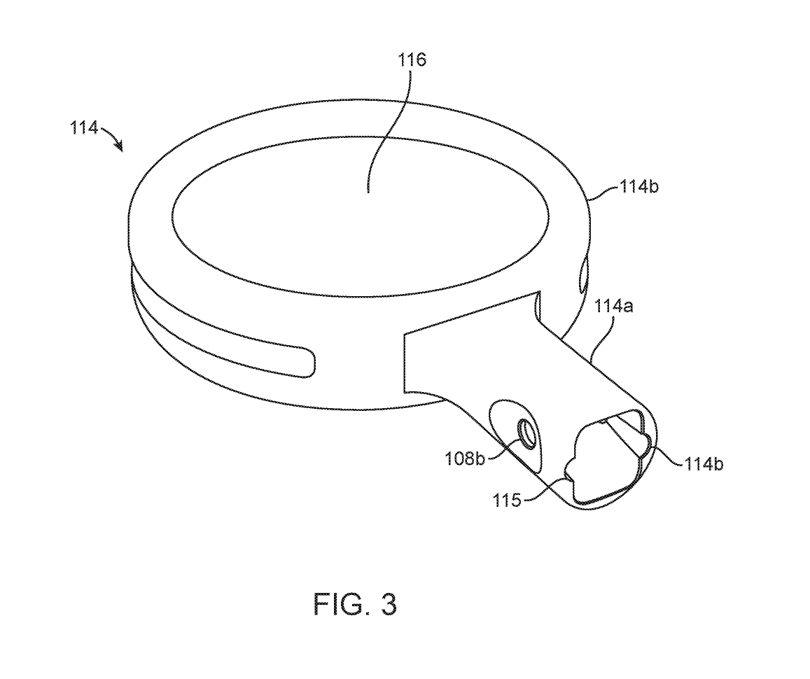

Another example of a fitting for use with the connectors 104 of the cable 100 is shown in FIG. 3. FIG. 3 illustrates a magnifying glass 114 having a female body 114a having the hole 108b and magnifying glass frame 114b attached to the female body 114a and holding a magnifying glass 116. As seen in FIG. 3, and inside of the female body 114a can include a tapered slot 115 for guiding the pin 108a of the connector 104 into the hole 108b.

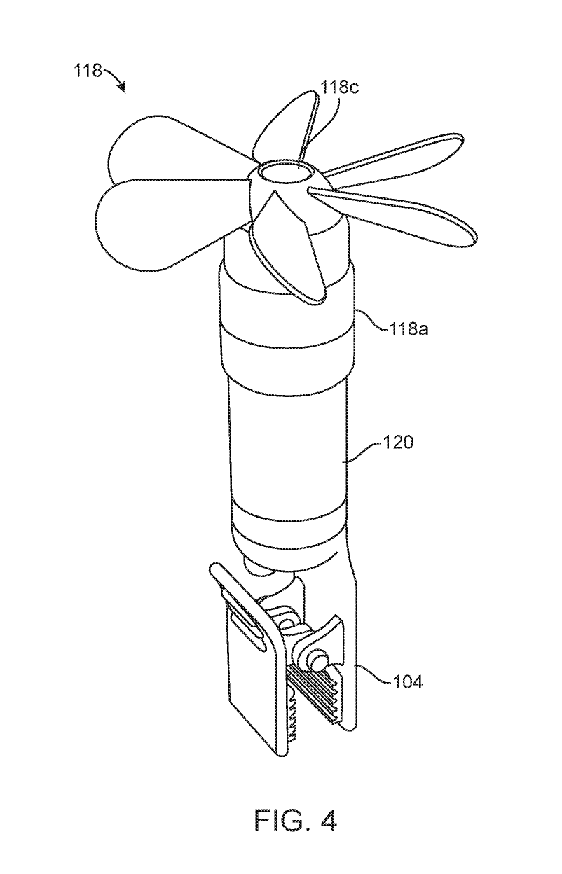

Yet another example of a fitting for use with the connectors 104 of the cable 100 is shown in FIG. 4. FIG. 4 illustrates a fan assembly 118. The fan assembly 118 can be configured as shown in FIG. 3 (that is, having a female body having the hole 108b for connection to the pin 108a of the connector 104) or be integral with one end of the cable 100 as shown in FIG. 4. In such configuration, the fan assembly 118 includes a motor 118a, fan 118b and alternatively a light 118c. A portion of the cable 100 can house a battery 120 for powering the motor 118a. The other end of the cable can include the alligator fitting 104 as described above, or any other suitable connector for attaching the fan assembly 118 to another object.

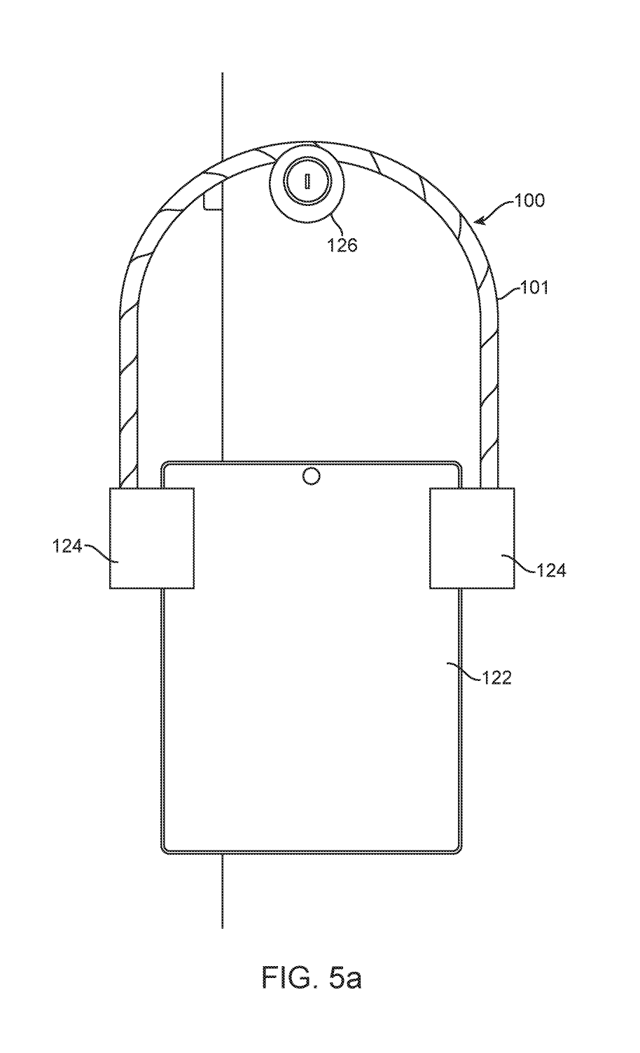

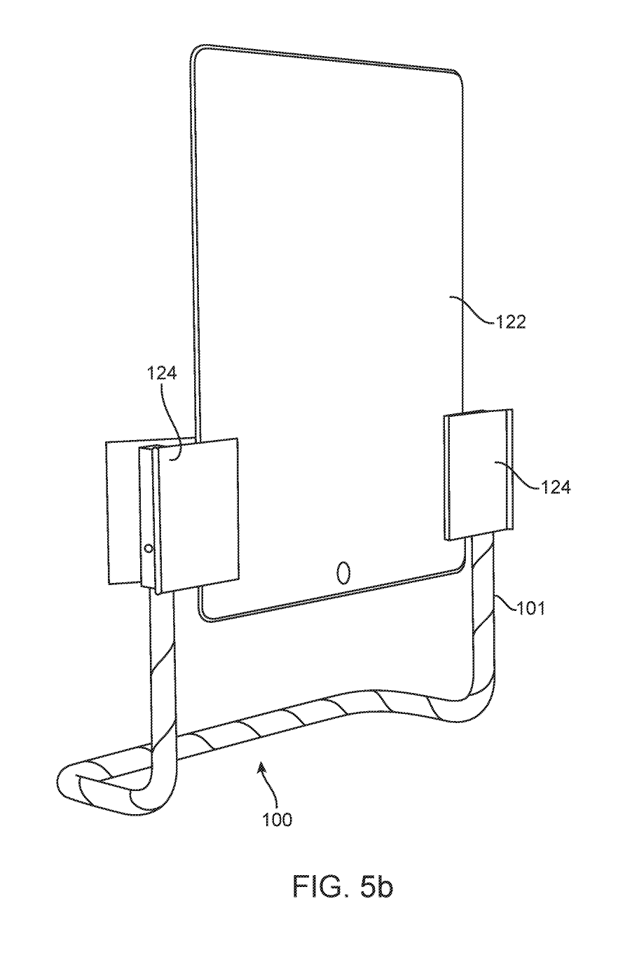

Referring now to FIGS. 5a and 5b, there is shown a cable 100 having fittings 124 attached to the end connectors 104 adapted to hold an object, such as a tablet 122. Also, the cable of FIGS. 5a and 5b include a flexible cover 101 that bends with the bending of the internal twisted wires 102, such as silicone or other elastomer. Other objects, such as other electronic devices (such as a smartphone) or non-electronic devices (such as a cookbook) can also be held with such fittings 124. The cable 100 of FIG. 5a being configured to hang the tablet 122, such as from a door knob 126, while the cable 100 of FIG. 5b being configured to stand the tablet 122 on another surface, such as a table or desk.

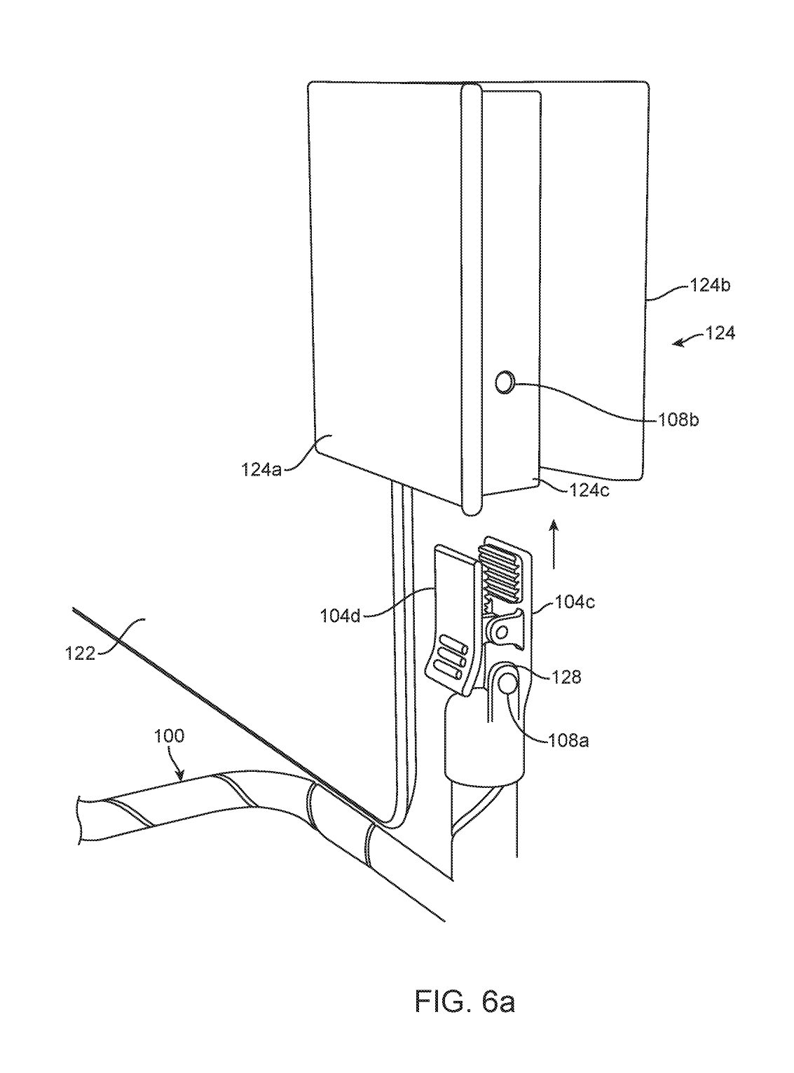

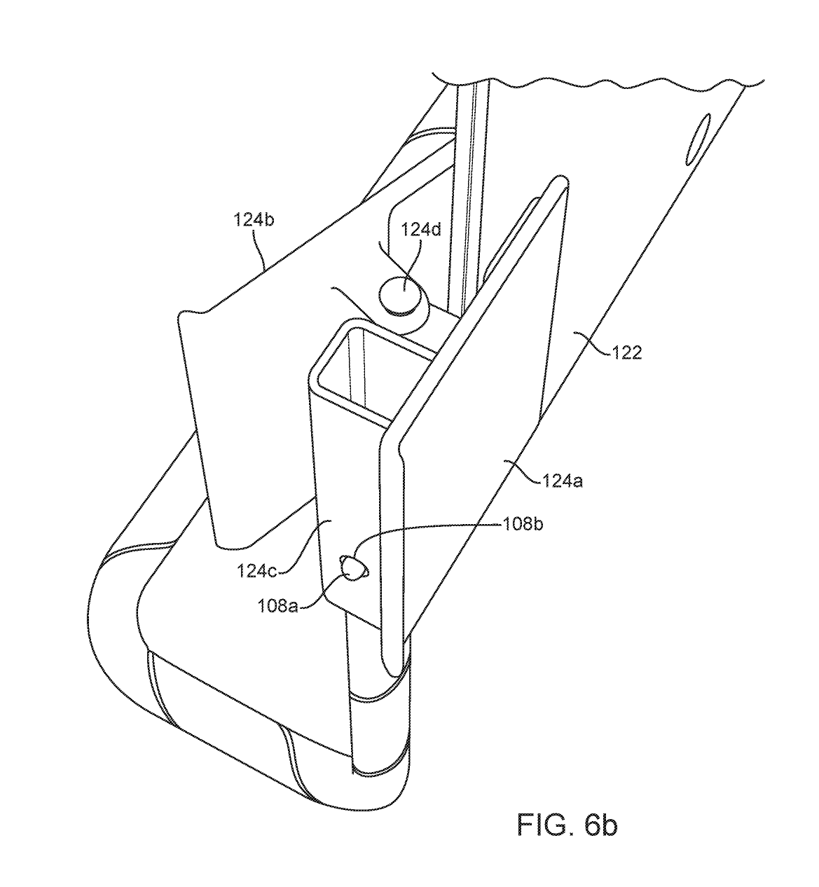

FIGS. 6a and 6b illustrate the fittings 124 of FIGS. 5a and 5b. Such fittings 124 are essentially similar to the alligator clip fittings 104 but having first and second jaws 124a, 124b offset 90 degrees from the first and second jaws 104c and 104d of the alligator clips and having internal surfaces configured to grasp delicate objects, such as electronic devices, securely while not damaging the same. The fittings 124 include a body 124c fixed to jaw 124a and jaw 124b rotatably connected thereto, such as by shaft 124d. As with the alligator clip connectors 104, jaw 124b is biased into a closed position with regard to jaw 124a, such as with a spring element. Also, as shown in FIG. 6a, the pin 108a of the connector 104 can be mounted on a spring member 128 having resiliency such that it can deform inwards and spring back. In such a configuration, when the pin 108a is engaged with the hole 108b on the fitting 124 (or any other fitting described herein), the fitting 124 can be disengaged by pushing the pin 108a inwards to release the same from the hole 108b and subsequently pulling the fitting 124 from engagement with the connector 104.

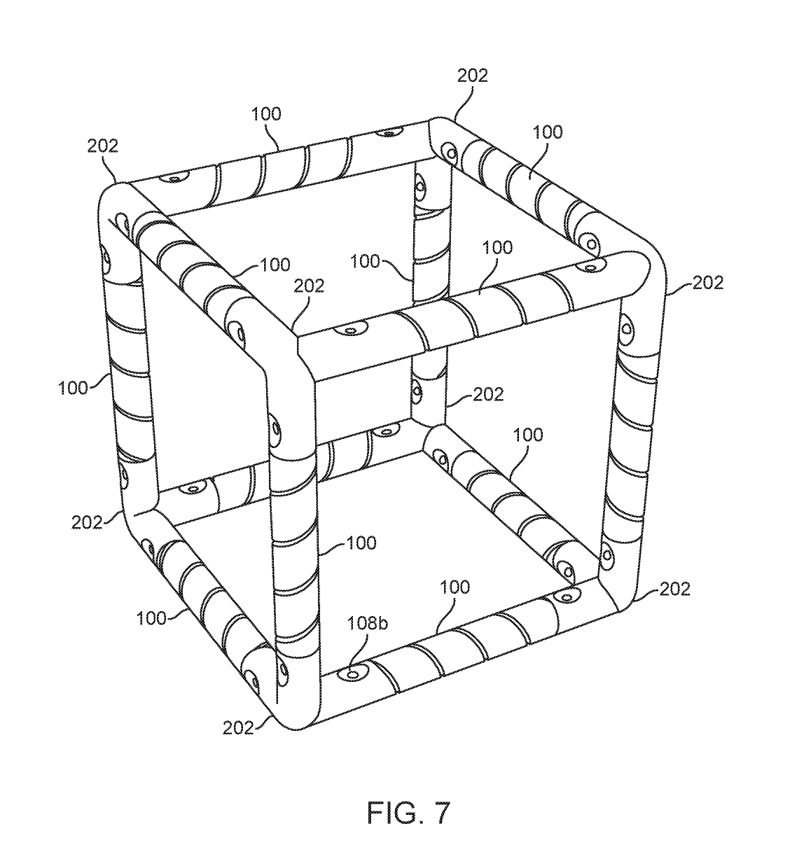

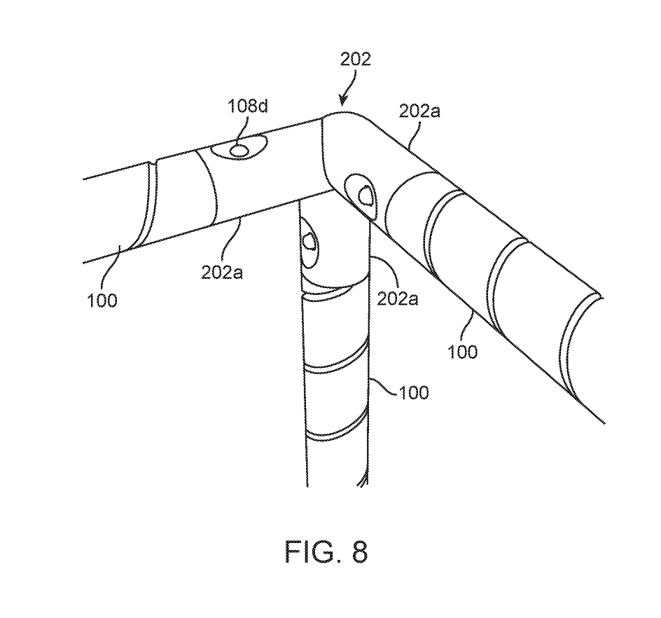

Referring now to FIG. 7, there is shown a plurality of the cables 100 connected together to form a portable structure, generally referred to by reference numeral 200, capable of supporting other objects, such as smart phones, tablets, books and the like making such structure particularly suitable in home, office and college dorm environments. The structure illustrated in FIG. 7 is a cube, however, those skilled in the art will appreciate from the following description of the various fittings shown in FIGS. 8-15 that infinite number of structure shapes and configurations are possible. The cube structure of FIG. 7 is shown with a single cable 100 at each edge of the cube and corner fittings 202, as shown in more detail in FIG. 8, having a body with three orthogonal female legs 202a, each having a hole 108b for engagement with a corresponding pin 108a of connector 104.

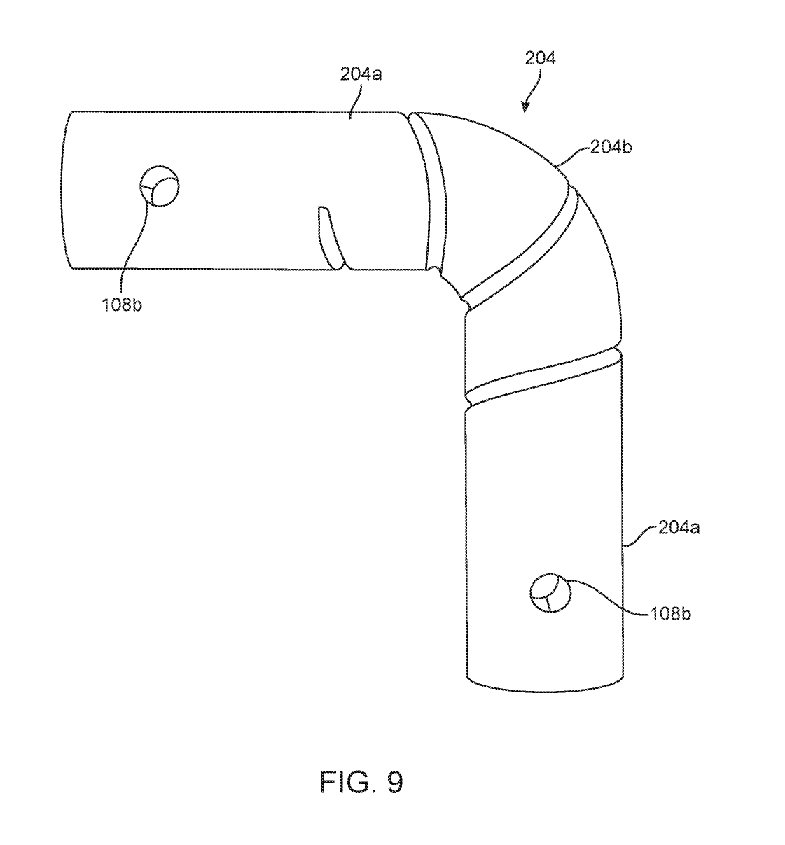

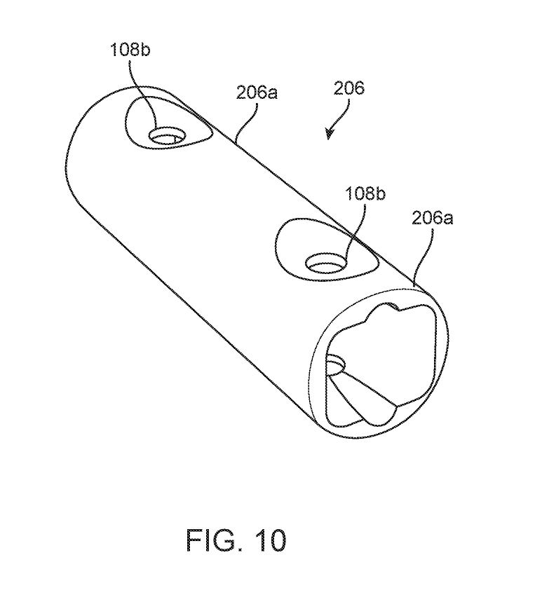

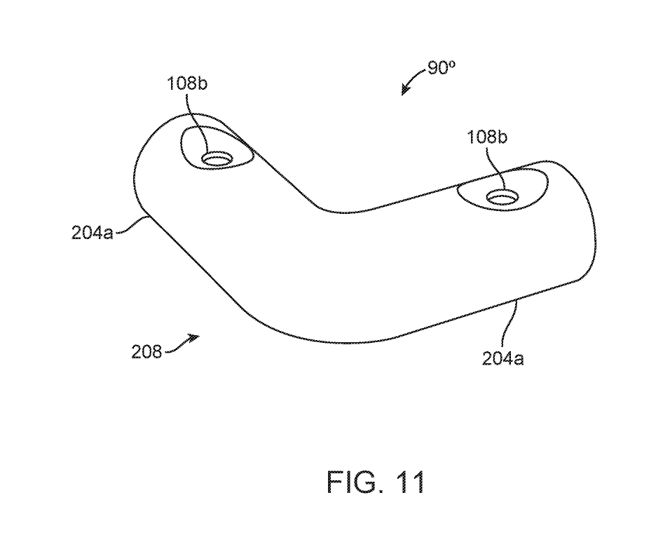

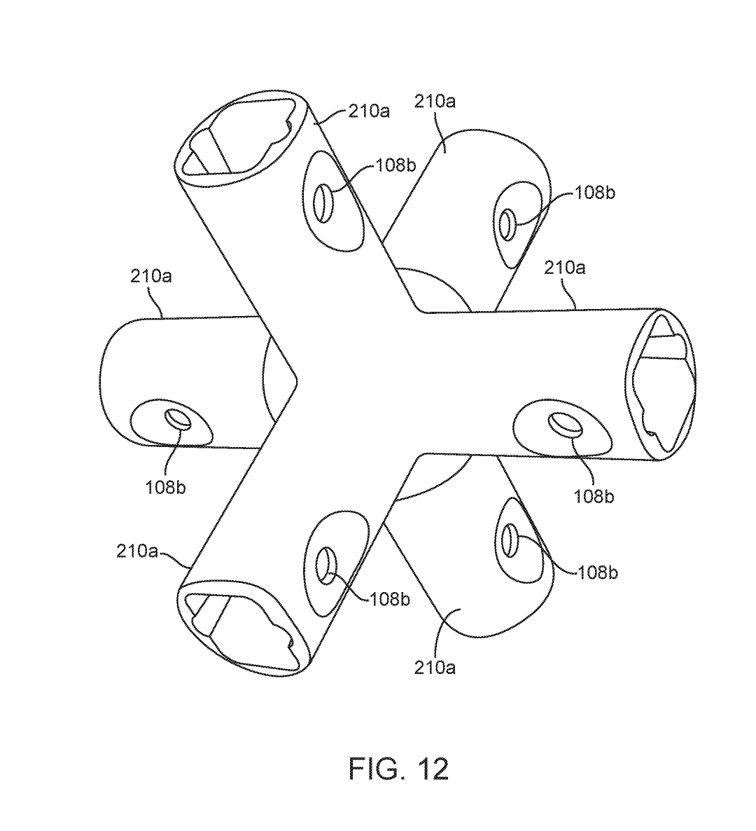

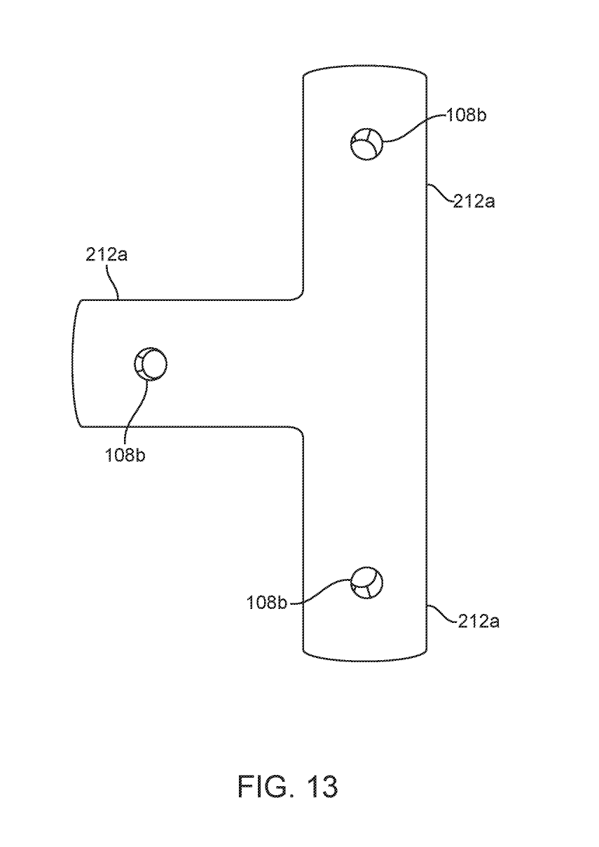

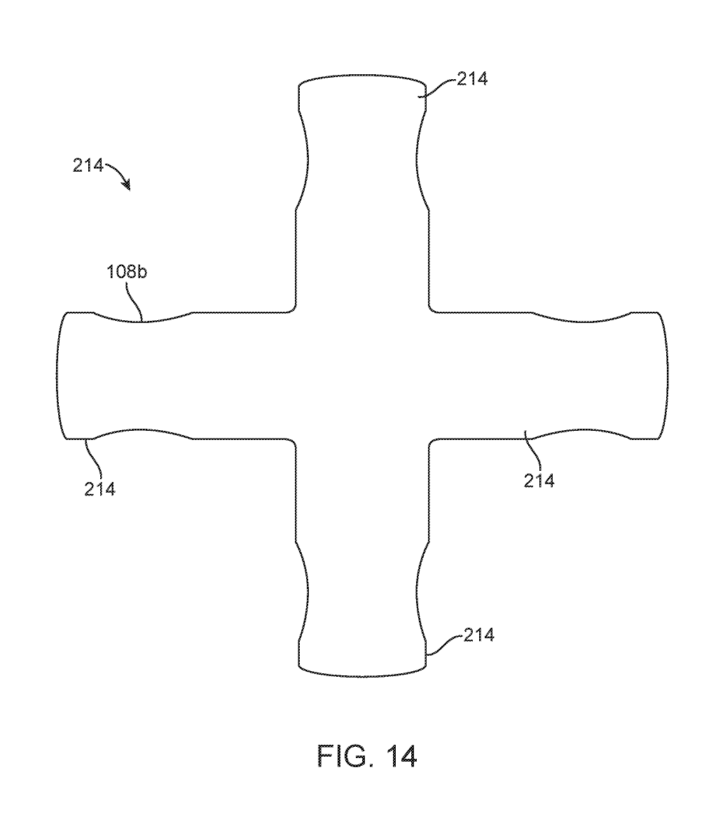

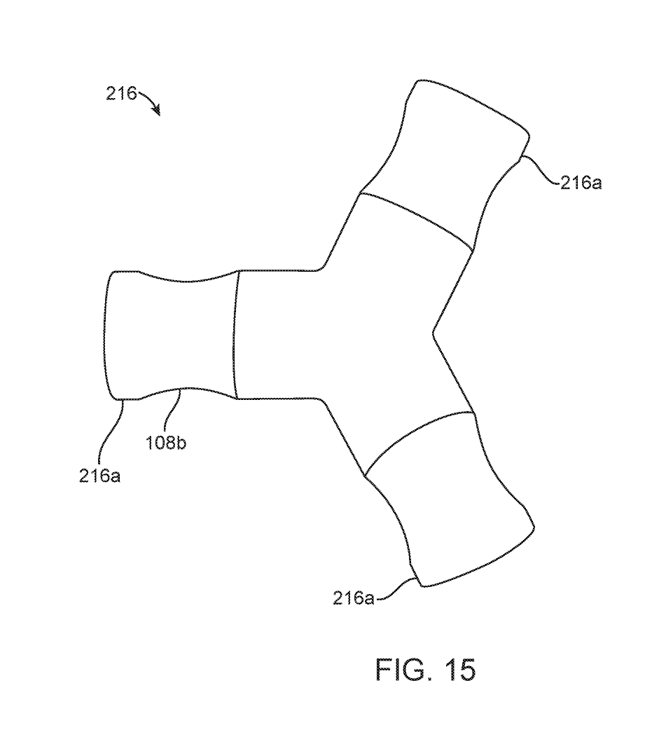

Other fittings for constructing such portable structures include an elbow 204, as shown in FIG. 9, having two female legs 204a, each with a hole 108b, where the female legs 204a are at a right angle relative to each other. In addition, the center region 204b of the elbow 204 can itself be flexible (similarly to the construction of the cable 100) such that the angular relationship between the female legs 204a can be varied. FIG. 11 shows a similar elbow 208 without the flexible center region 204b. FIG. 10 shows a straight coupling 206 having two female legs 206a at 180 degrees from each other and each having a hole 108b for connection to a corresponding pin 108a of a fitting 104. FIG. 12 shows a multiple coupling 210 having six female legs 210a and each having a hole 108b for connection to a corresponding pin 108a of a fitting 104. FIG. 13 shows a T coupling 212 having three female legs 212a and each having a hole 108b for connection to a corresponding pin 108a of a fitting 104. FIG. 14 shows a cross coupling 214 having four female legs 214a at 90 degrees from each other and each having a hole 108b for connection to a corresponding pin 108a of a fitting 104. FIG. 15 shows a Y coupling 216 having three female legs 216a and each having a hole 108b for connection to a corresponding pin 108a of a fitting 104. Although only the fitting of FIG. 9 is described as having a flexible region, any of the fittings of FIGS. 8-15 can have one or more of such flexible regions.

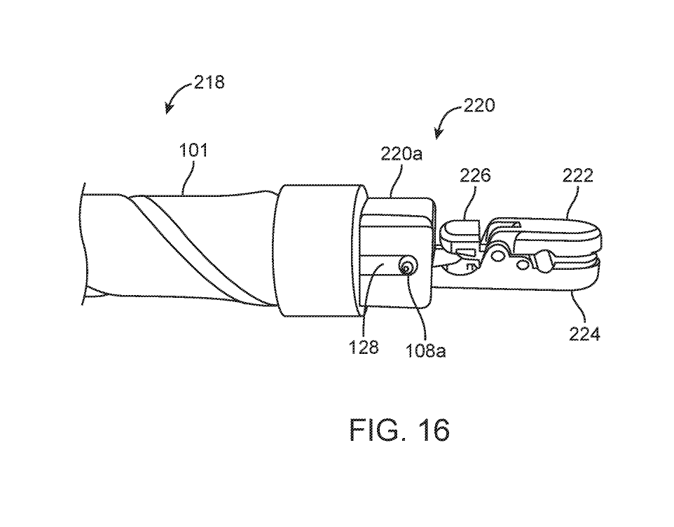

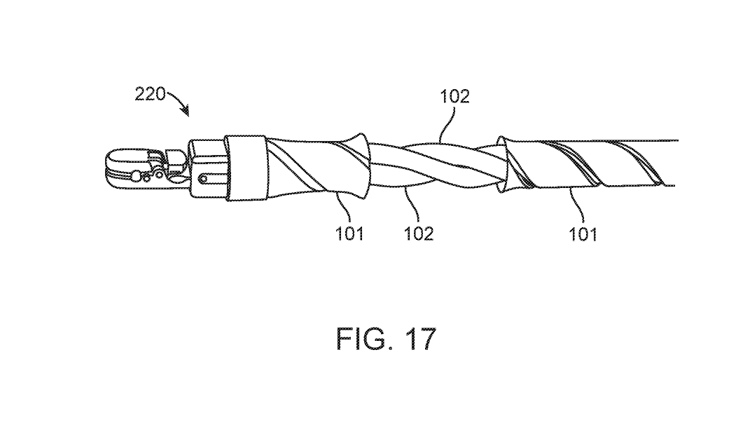

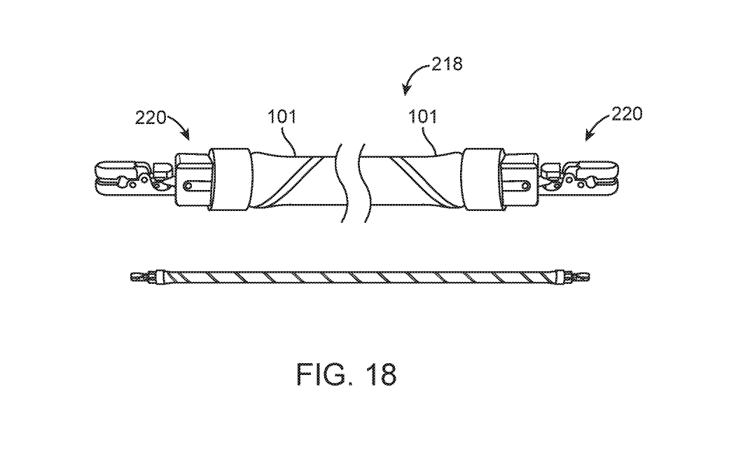

Referring now to FIGS. 16-18, there is shown another cable, generally referred by to reference number 218. Such cable 218 is similar to that described above (100) except for a different connector 220 disposed at each end thereof. Such connectors 220 are disposed on the twisted wires 102 (see FIG. 17) in the same ways as described above and also include a body 220a having a pin 108a, which may be disposed on a spring member 128. Connector 220 also includes a fixed jaw 224 connected to the body and a movable jaw 222 rotatable about a pivot to open and close relative to the first jaw 224. However, instead of being biased into the closed position, the jaws 222, 224 are operated by a tab 226 to open and close. Lifting the tab 226 opens the movable jaw 22 relative to the fixed jaw 224 and pushing the tab 226 down (as is shown in FIG. 16) both closes the movable jaw 22 relative to the fixed jaw 224 and locks the same in place. The configuration and operation of the connector 220 is disclosed in U.S. Patent Application Publication No. 2010/0313390, the contents of which is incorporated herein by reference. FIG. 17 shows the cable 218 of FIG. 16 in which a portion of the cover 101 is removed to expose the twisted wires 102. FIG. 18 shows a complete cable 218 with the connectors 220 disposed at each end thereof. Any of the fittings described above can also be used with the connector 220 by engaging a hole 108b thereof with the pin 108a.

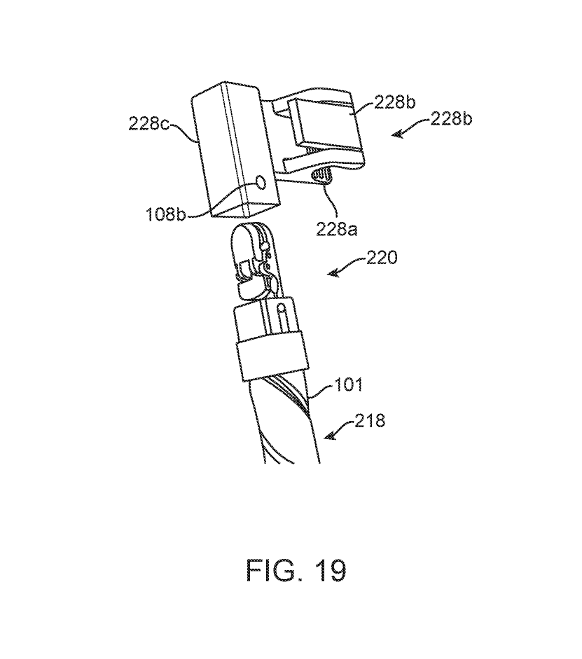

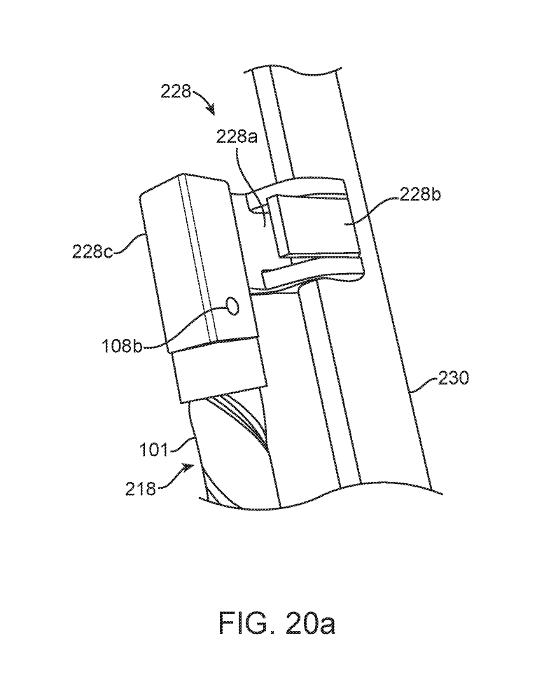

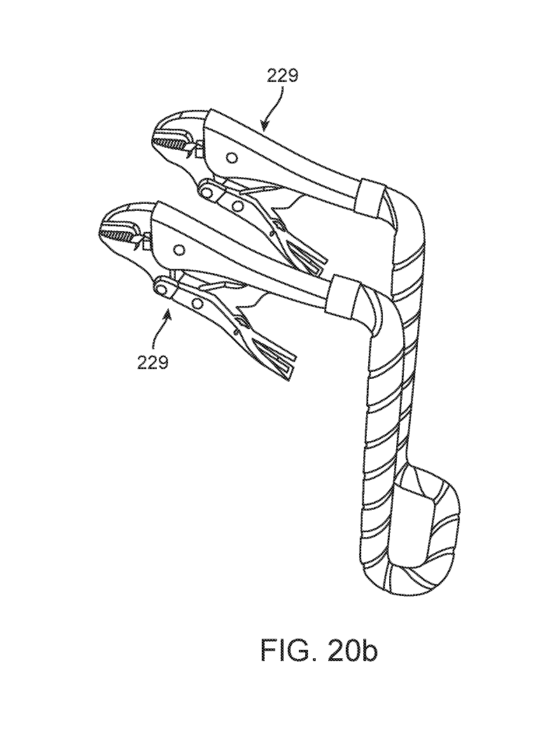

FIGS. 19-23 illustrate fittings 228 used with connectors 220 (or with connectors 104 described above). Such fittings 228 are similar to fittings 124 described above, such as having first and second jaws 228a, 228b offset 90 degrees from the first and second jaws 224 and 222 of the connector 220 and having internal surfaces configured to grasp delicate objects, such as electronic devices, securely while not damaging the same. The fittings 228 include a body 228c fixed to jaw 228a and jaw 228b rotatably connected thereto, such as by a shaft. However, unlike fitting 124, jaw 228b is not biased into a closed position with regard to jaw 228a. Instead, jaw 228b includes an internal cam surface as is known in the art that interferes with a surface of the object 230 being grasped such that the jaw 228b can be locked in place by such interference. As shown in FIG. 20a, the fitting 228 is configured to grasp a certain sized object. However, the fitting 229 can be capable of grasping objects of varying sizes, such as being configured with vice-grips, which are well known in the art of grasping and clamping onto various sized objects.

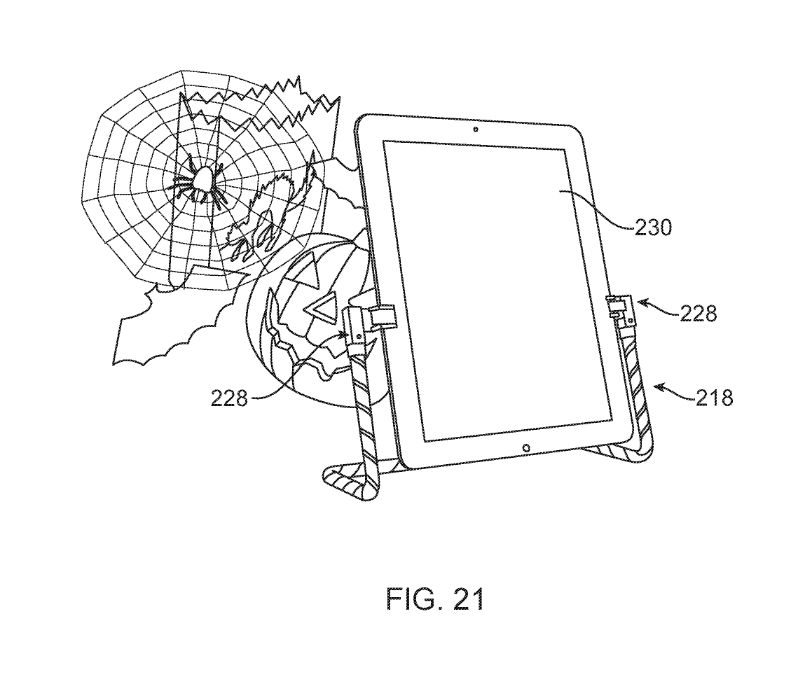

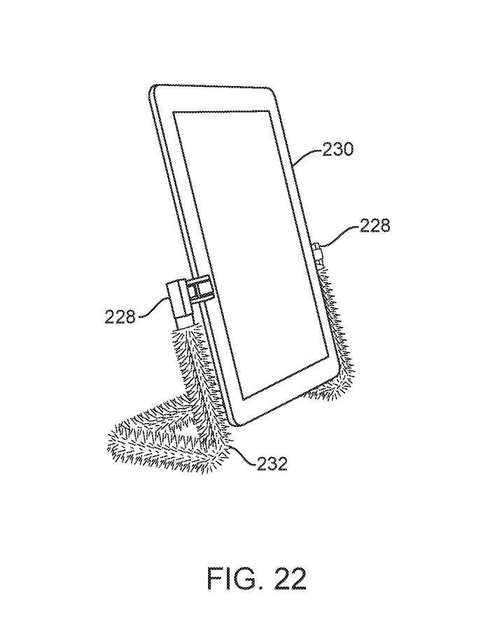

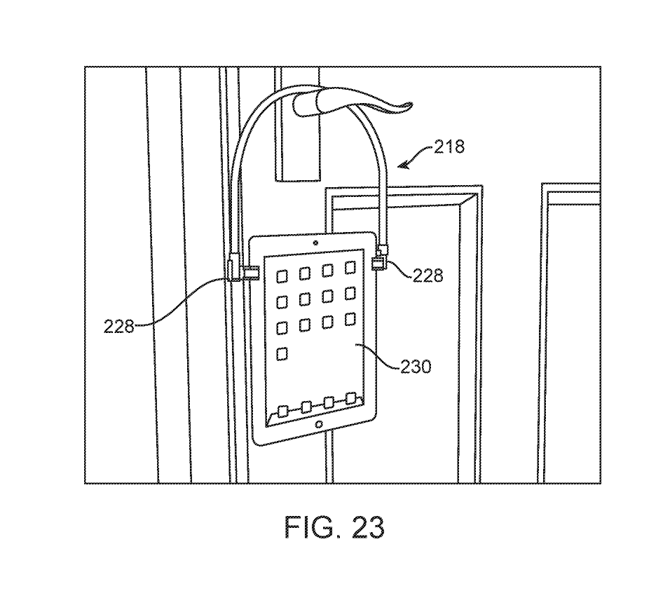

As shown in FIG. 21-23, such object can be an electronic device, such as a tablet. As discussed above, the cable 218 can be configured to stand such object 230 as shown in FIGS. 21 and 22 or hung, such as shown in FIG. 23.

As shown in FIG. 21, the cover 101 can be decorated in colors, such as to represent a season or holiday (such as Halloween) or include images, such as sports logos, cartoon characters, movie themes etc. As shown in FIG. 22, the cover can be replaced by fibers 230 inserted between the twists of the wires 102 to look like a Christmas tree branch or merely to have a fuzzy appearance.

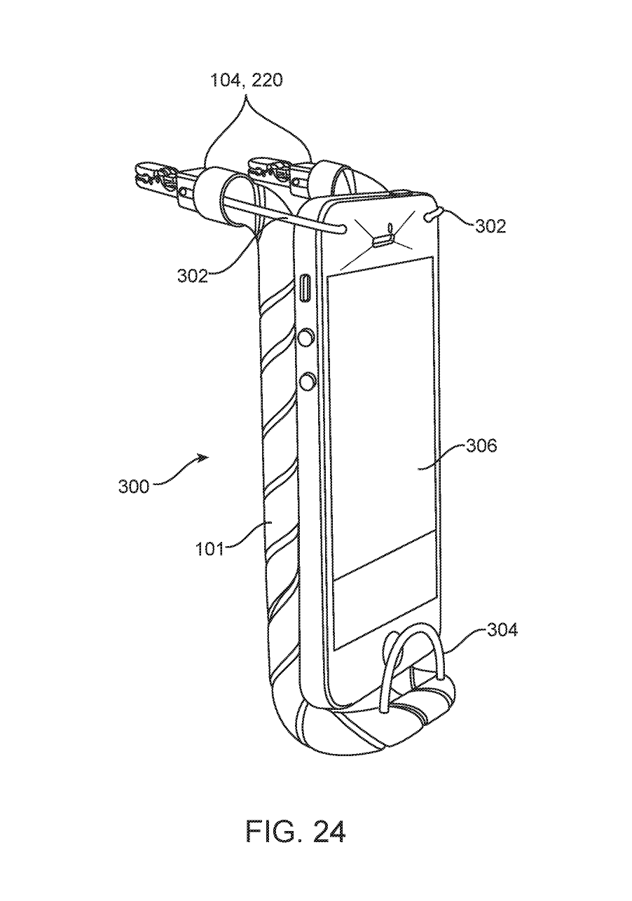

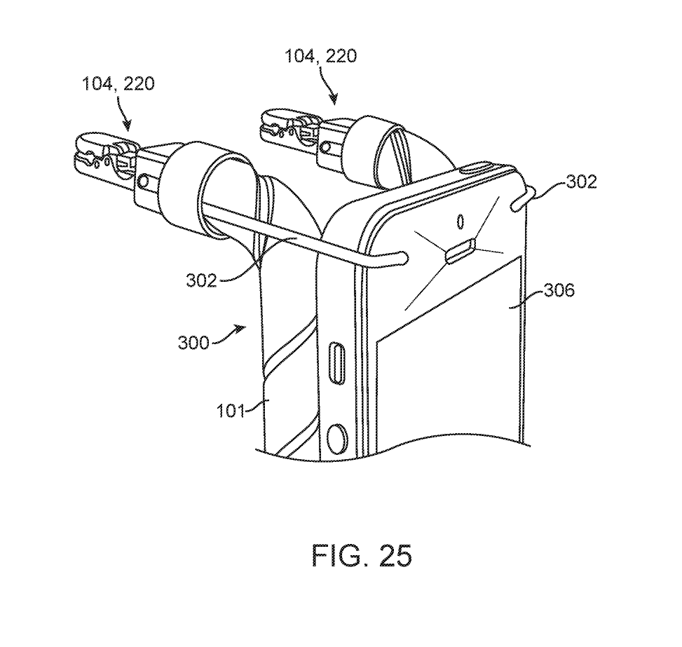

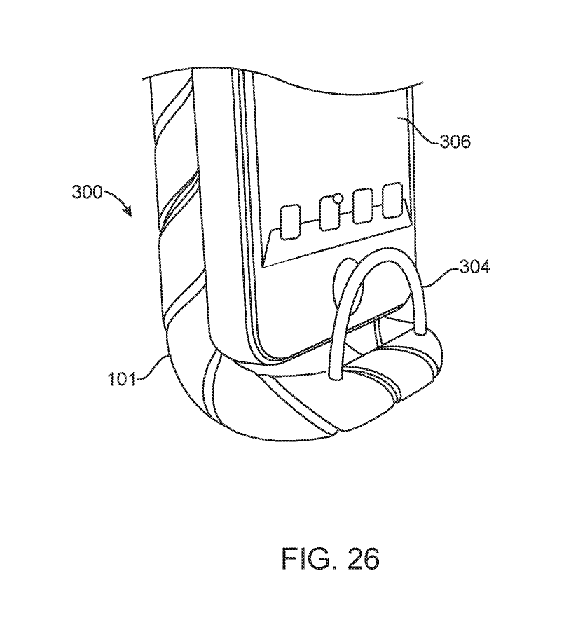

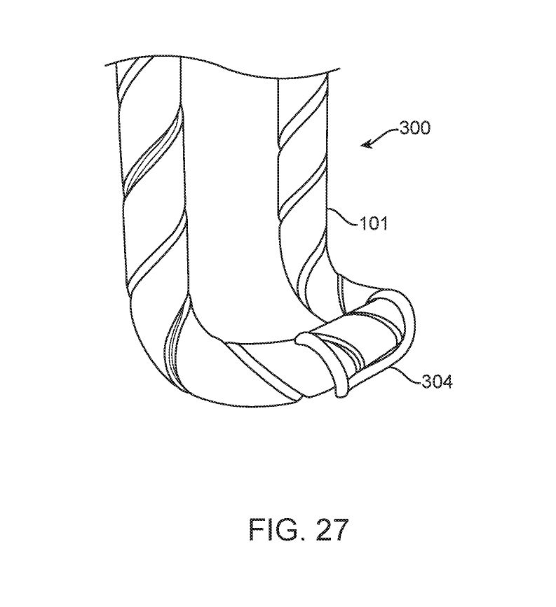

Referring now to FIGS. 24-27, there is described another variation of a cable, generally referred to by reference numeral 300. The cable 300 is similar to cables 100, 218 described above having a pair of twisted wires 102, cover 101 and connectors 104, 220 at each end thereof. However, such cable 300 further includes additional wires 302, 304 for supporting another object, such as an electronic device (such as a smartphone 306 shown in FIG. 24). As shown in FIG. 25, wires 302 are disposed at the connectors 104, 220 and are flexible so as to conform to the object 306 being supported (once the cable 300 is configured to generally conform to a shape of the object 306). Such wires can be extensions of the twisted wires 102 are separately provided, such as being fitting between the cover 101 and connector 104, 220. As shown in FIG. 25, ends of the wires 302 are bent inwards to support the object 306. As shown in FIG. 26, another wire 304 is provided between the connectors 104, 220 so as to support the object 306 at another position, in this case the wire 304 is connected to the cable 300 at each end so as to form a closed shape with the cable 300. However, two additional wires may take the place of single wire 304 or wire 304 may be only connected to the cable at one end (similar to wires 302). As shown in FIG. 27, the wire 304 may be folded on the cable 300 when not be used (as can wires 302).

Any of the configurations of cables, connectors, fittings, additional wires may be used in combination with each other and with each embodiment described above.

While there has been shown and described what is considered to be preferred embodiments of the invention, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

What is claimed is:

1. A cable for supporting an electronic device having a display, the cable comprising:
a body having two or more elongated wires twisted together to form a helically wound pair of wires having two ends; and
a connector disposed at each of the two ends, each connector having first and second jaws rotatably disposed relative to each other about a pivot joint so as to be openable and closable relative to each other, the first jaw having a first plate extended from the pivot joint, the second jaw having a second plate extended from the pivot joint, the first and second plates being biased towards each other and configured to hold the electronic device so as to direct the display to a user;
wherein at least a portion of the body has a rigidity such that the portion can be shaped into a predetermined configuration and maintained in the predetermined configuration under a weight of the electronic device with the display being directed to the user.

2. The cable of claim 1, further comprising a cover for one of individually covering each of the elongated wires or covering the helically wound pair of wires.

3. The cable of claim 1, wherein each connector further comprises a body, a third jaw fixed to the body and a fourth jaw rotatably disposed on the body to open and close relative to the third jaw, wherein the body, the third jaw and the fourth jaw being removably connected to a channel arranged in one of the first and second jaws.

4. The cable of claim 3, wherein the third jaw is biased in a closed position relative to the fourth jaw.

5. The cable of claim 3, wherein each connector includes means for releasably connecting the body from the channel.

6. The cable of claim 5, wherein the means for releasably connecting includes a pin projecting from a surface of the body for engaging with a corresponding hole on the channel.

7. The cable of claim 6, wherein the pin is biased in a position extending from an exterior surface of the channel such that depressing the pin into the hole releases the body from the channel.
